(19) United States
(12) Patent Application Publication
(10) Pub. No.: US 2021/0090464 A1
(43) Pub. Date: Mar. 25, 2021

(54) EARLY CHILDHOOD TRAINING AND DEVELOPMENT GAME

(71) Applicant: Lil Advents LLC, Renton, WA (US)

(72) Inventors: Mindy WRIGHT, Renton, WA (US); Brandon WRIGHT, Renton, WA (US)

(21) Appl. No.: 17/019,989

(22) Filed: Sep. 14, 2020

Related U.S. Application Data
(60) Provisional application No. 62/906,056, filed on Sep. 25, 2019.

(51) Int. Cl. G09B 19/00

(52) U.S. Cl. CPC G09B 19/0076

(57) ABSTRACT

An early childhood training and development game apparatus and method are shown involving a body with a top surface formed therein and multiple compartments. Multiple incentive objects are formed on the top surface and are positioned so that each incentive object is adjacent to a corresponding compartment. Each incentive object includes a progress tracking region having one or more achievement marks and a removable cover. A reward object is placed in each of the compartments. When a child has earned a progress token for each achievement mark in the progress tracking region for an incentive object, then the child is permitted to remove the removable cover to disclose and release the reward object in the corresponding compartment.

### CROSS REFERENCE TO RELATED APPLICATIONS

This application claims the benefit of U.S. Provisional Patent Appl. No. 62/906,056 for “EARLY CHILDHOOD TRAINING AND DEVELOPMENT GAME” filed Sep. 25, 2019, herein incorporated by reference in its entirety for all purposes.

### BACKGROUND

Young children are often highly receptive to incentives in return for desired behavior. As a result, a system of incentives can sometimes be utilized to engage the interest of children to change their behavior.

For example, a particular behavior, such as toilet training or learning to count, can be identified for modification and a incentive given to a child for performing or refraining from the particular behavior. For instance, a sticker chart can be provided and sticker given to a child to incentive the child's behavior.

Currently, parents and caretakers can find it difficult to provide an attractive, interesting system to encourage behavior modification or development in young children.

### SUMMARY

According to one aspect of the present invention, in an example of an apparatus for an early childhood training and development game, the game has a body with a top surface formed therein and including a plurality of compartments. Multiple incentive objects are formed on the top surface, where each incentive object is positioned adjacent to a corresponding one of the compartments and includes a progress tracking region and a removable cover. The game also includes incentive objects, where each incentive object is contained in a corresponding compartment.

In some examples, a shape of the progress tracking region and a shape of the removable cover for each incentive object are selected to produce a shape of the incentive object that can be relevant to an intent of the game. In certain examples, the shape of the incentive object can be an image of a toilet.

In other examples, an image is formed or provided on the removable cover for each incentive object. In particular examples, the image formed or provided on the removable cover for each incentive object can be a cartoon image. In specific examples, the cartoon image can be a farm animal, a vehicle or a dinosaur. In yet other examples, each of the incentive objects corresponds to the image formed or provided on the removable cover for each incentive object.

In still other examples, the compartments are formed in the body. In other examples, the compartments are formed in a substrate that is enclosed within the body.

An example of a method for early childhood training and development in accordance with this disclosure involves providing a game apparatus having a plurality of compartments. Each compartment has a reward object disposed therein and an incentive object, where each incentive object has a removable cover that covers an opening formed in the compartment and the incentive object has a progress tracking region with one or more achievement marks. For each of the incentive objects, progress tokens can be provided to a child as a reward for an action by the child, who affixes the progress token to an achievement mark in the progress tracking region of the incentive object. When each of the achievement marks for the incentive object has a progress token affixed to it, the child can remove the removable cover from the incentive object to open the compartment and reveal the reward object.

In another example of an apparatus for early childhood training and development, the apparatus includes a plurality of compartments, where each compartment has a reward object disposed therein and a plurality of incentive objects, each incentive object having a removable cover that covers an opening formed in a corresponding one of the compartments and the incentive object having a progress tracking region with one or more achievement marks.

In certain examples of this apparatus, a shape of the progress tracking region and a shape of the removable cover for each incentive object are selected to produce a shape of the incentive object that is relevant to an intent of the game. In certain examples, the shape of the progress tracking region and the shape of the removable cover incentive object form an image of a toilet.

Further, in particular examples, an image is formed or provided on the removable cover for each incentive object. In some of these examples, the image formed or provided on the removable cover for each incentive object is composed of a cartoon image, such as farm animal cartoon images, a plurality of vehicle cartoon images and a plurality of dinosaur cartoon images.

### BRIEF DESCRIPTION OF THE DRAWINGS

Various embodiments in accordance with the present disclosure will be described with reference to the drawings, in which:

FIG. 1 is a schematic diagram that illustrates one example of an early childhood training and development game according to certain aspects of the present invention;

FIG. 2 is a cross-sectional side view diagram that illustrates one example of compartments containing incentives in accordance with the early childhood training and development game of FIG. 1; and

FIGS. 3A and 3B are schematic diagrams illustrating an example of a removable cover for the compartments of the early childhood training and development game example of FIG. 2.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Examples are discussed herein of an early childhood training and development game that involves incentive objects, such as toys, contained with compartments. Incentive objects are formed or provided on a top surface of a body of the game, where each incentive object includes a removable cover that can be removed to open one of the compartments to reveal a toy.

In certain examples, each incentive object includes a progress tracking region for tracking a child's progress. Each time the child successfully completes an act, such as using a toilet, the child receives a tracking token, such as a sticker, that can be applied to a progress marker in the progress tracking region. When tracking tokens have been applied to each progress marker in the progress tracking region for an incentive object, the child can be permitted to remove the removable cover for the incentive object and reveal the toy contained in the corresponding compartment.

A shape of the incentive objects, such as the shape formed by the progress tracking region and the removable cover, can be selected in accordance with the intent of the game. For example, the shape can be a toilet in a game intended for toilet training for a child.

Images, such as cartoon images, can also be provided on the removable covers to interest the child. The cartoon images can be selected to relate to a theme of the game, such as farm animals, vehicles, or dinosaurs. The incentive objects can also be selected to relate to the theme of the game, such as toy farm animals, vehicles, or dinosaurs.

The compartments can be formed in the body of the game or in a substrate, such as plastic blister packs, enclosed in the body.

In an example of a method for early childhood training and development in accordance with this disclosure, a game apparatus us provided having a plurality of compartments. Each compartment has a reward object disposed therein and an incentive object, where each incentive object has a removable cover that covers an opening formed in the compartment and the incentive object has a progress tracking region with one or more achievement marks. For each of the incentive objects, progress tokens can be provided to a child as a reward for an action by the child, who affixes the progress token to an achievement mark in the progress tracking region of the incentive object. When each of the achievement marks for the incentive object has a progress token affixed to it, the child can remove the removable cover from the incentive object to open the compartment and reveal the reward object.

In another example of an apparatus for early childhood training and development, the apparatus includes a plurality of compartments, where each compartment has a reward object disposed therein and a plurality of incentive objects, each incentive object having a removable cover that covers an opening formed in a corresponding one of the compartments and the incentive object having a progress tracking region with one or more achievement marks.

These examples are provided for purposes of illustration only and do no limit the scope of the disclosure.

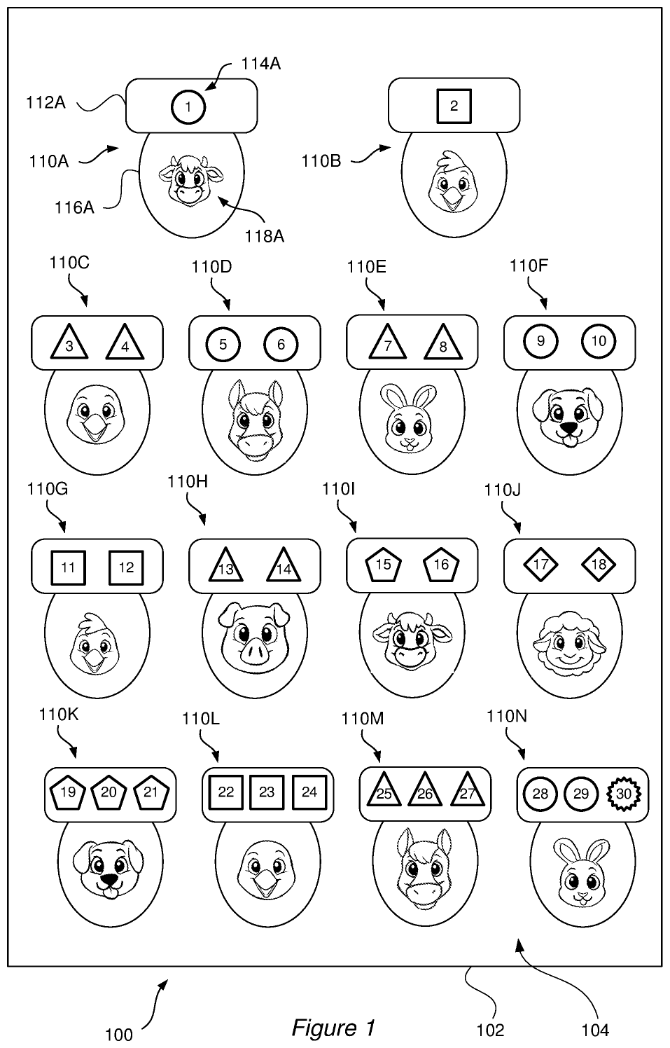

FIG. 1 is a schematic diagram that illustrates one example of an early childhood training and development game 100 according to certain aspects of the present invention. In this example, the game 100 is configured for toilet training a child by tracking each time the child utilizes a toilet using progress tokens attached to the game and progressively incentivizing or rewarding the child with objects, such as toys, that are sealed in compartments in the game using a removable cover, such as a tear-away film, cardboard or an adhesive film.

In the example of FIG. 1, a body 102 has a top surface 104. Body 102 can be a box, such as a plastic or cardboard box, that can be composed of subcomponents or include subcomponents. For example, a plurality of side panels and a back panel of body 102 can be composed of cardboard and top surface 104 can be composed of plastic that is adhered to side panels of body 102. Many variations can be utilized with departing from the teachings of the disclosed approach.

A plurality of incentive objects 110 are provided or formed on the top surface of game 104. Each incentive object 110 can include a progress tracking region 112 and a removable compartment cover 116, which can include a decorative symbol or image 118, such as a cartoon image of an animal or a vehicle, rendered on the removable compartment cover 116.

Progress tracking region 112 can include one or more achievement marks 114. When a child performs a task, which is the successful use of a toilet in this example, the child is incentivized with a progress token, such as a sticker or a badge, that is applied to an achievement mark 114 to track the child's progress. The symbols for each achievement mark can include a variety of shapes, such as circles, triangles or squares, and colors, such as red, yellow or blue. The progress token, in certain examples, can be a star-shaped or circular sticker.

The number of achievement marks 114 in a progress tracking region 112 for an incentive object 110 can also vary. For example, incentive object 110A has one achievement mark 114A in its progress tracking region 112A. Similarly, incentive object 110B has one achievement mark 114B. The number of achievement marks in the progress tracking of an incentive object can be progressively increased to challenge the child. For example, incentive objects 110C-J each have two achievement marks in their corresponding progress tracking regions 112 while incentive objects 110K-N each have three achievement marks in their corresponding progress tracking regions 112.

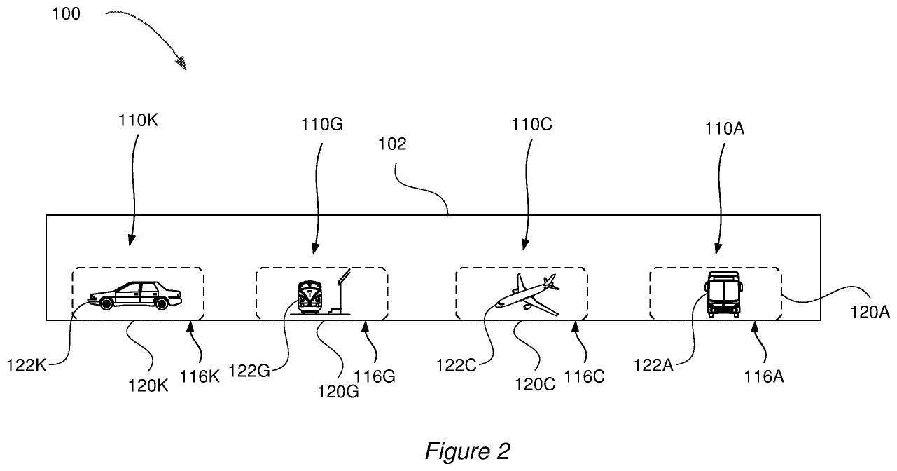

FIG. 2 is a cross-sectional side view diagram of the body 102 that illustrates one example of a plurality of compartments 120 formed or provided in the body 102 for each of the incentive objects 110 that contain reward objects 122 in accordance with the early childhood training and development game of FIG. 1. Each incentive object 110 has a corresponding compartment 120 that contains a corresponding reward object 122 and is sealed using removable cover 116. For example, incentive object 110A has corresponding compartment 120A positioned in body 102 such that removal of cover 116A opens compartment 120A to reveal reward object 122A, such as a toy. The removable compartment cover 116 covering a compartment 120 containing a reward object 122 can be opaque to conceal the reward object, transparent to reveal the reward object, or translucent to pique the child's interest without completely revealing the reward object.

In one example, the compartments 120 are formed as blister packs in a plastic substrate that includes top surface 104. In another example, the compartments 120 are formed in a separate substrate, such as a formed plastic tray, that is enclosed in body 102 and adjacent to top surface 104.

When the child has marked all of the achievement marks 114 in a progress tracking region 112 for an incentive object 110, then the child can be permitted to remove the corresponding compartment cover 116 for the incentive object 110 to open a corresponding compartment 120 containing a reward object 122, such as a toy, for the child.

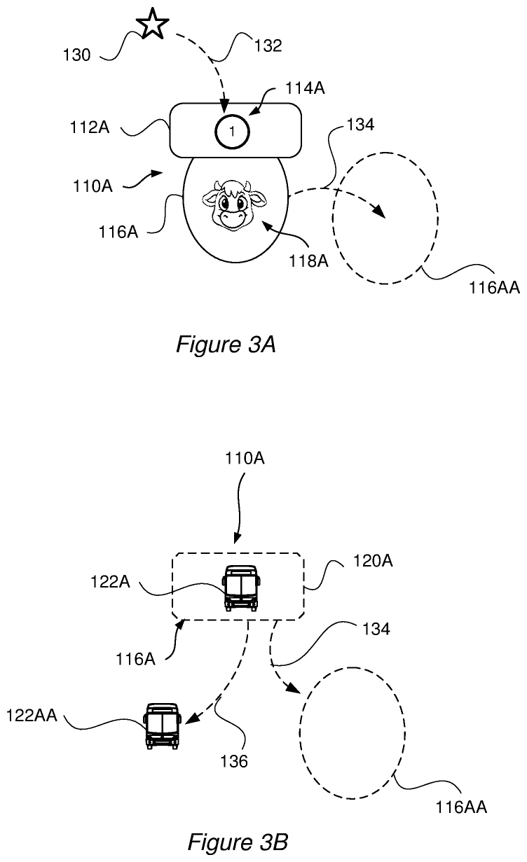

FIGS. 3A and 3B are schematic diagrams that further illustrate the example incentive object 110A of FIGS. 1 and 2. FIG. 3A illustrates a progress token 130, which is star-shaped in this example, that is given to a child to incentivize or reward an action, e.g. using a toilet, learning a new word, counting, etc. Examples for progress token 130 can include a sticker, a pin, or a badge that can be affixed, as illustrated at 132 in FIG. 3A, to achievement mark 114A in progress tracking region 112A for an incentive object 110A.

When all of the achievement marks 114 in the progress tracking region 112 of an incentive object 110 have had a progress token affixed to them, then the child can be permitted to open the compartment 120 for incentive object 110A by removing the removable cover 116A for the incentive object 110A, as illustrated at 134 in FIGS. 3A and 3B along with removed cover 116AA. Removal of cover 116A reveals a reward object 122A, which can be removed by the child, as illustrated at 136 in FIG. 3B, where reward object 122A is taken out of compartment 120A as demonstrated by removed reward object 122AA.

The example illustrated in FIGS. 1, 2, 3A and 3B is directed toward an early childhood training and development toilet training game 100. As a result, the shape of incentive objects 110, which results from the combination of the shapes of region 112 and removable cover 116, is selected to represent a toilet seat. In early childhood training and development games directed toward different types of training, the shape of the incentive objects 110 can be configured to represent other types of objects that can be related to the intent of the game, such as learning native or foreign language words, spelling, counting, or sharing.

Similarly, the images 118 presented on the removable covers 116 can vary, such as to illustrate vehicles, dinosaurs, or other subject matter of interest to children. The images 118 can be coordinated with the nature of reward objects 122, such as showing farm animal images 118 in connection with farm animal toys 122. The images 118 and reward objects 122 can also be selected to relate to the intent of the game. In another example, the images 118 and reward objects 122 can relate to learning a new word in a native or foreign language.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

We claim:

1. An early childhood training and development game apparatus, the apparatus comprising:
a body having a top surface formed therein and including a plurality of compartments;
a plurality of incentive objects formed on the top surface, each incentive object being positioned adjacent to a corresponding one of the plurality of compartments and including a progress tracking region having one or more achievement marks and a removable cover; and
a plurality of reward objects, where each one of the plurality of reward objects is disposed in a corresponding one of the plurality of compartments.

2. The apparatus of claim 1, wherein a shape of the progress tracking region and a shape of the removable cover for each incentive object are selected to produce a shape of the incentive object that is relevant to an intent of the game.

3. The apparatus of claim 2, wherein the shape of the progress tracking region and the shape of the removable cover incentive object form an image of a toilet.

4. The apparatus of claim 1, wherein an image is formed or provided on the removable cover for each incentive object.

5. The apparatus of claim 4, wherein the image formed or provided on the removable cover for each incentive object comprises a cartoon image.

6. The apparatus of claim 5, wherein the cartoon image comprises one of a plurality of farm animal cartoon images, a plurality of vehicle cartoon images and a plurality of dinosaur cartoon images.

7. The apparatus of claim 5, wherein each of the plurality of reward objects corresponds to the cartoon image formed or provided on the removable cover for a corresponding incentive object.

8. The apparatus of claim 1, wherein the plurality of compartments is formed in the body.

9. The apparatus of claim 1, wherein the plurality of compartments is formed in a substrate disposed within the body.

10. A method for early childhood training and development, the method comprising:
providing a game apparatus, the game apparatus having a plurality of compartments, each compartment having a reward object disposed therein and an incentive object, the incentive object having a removable cover that covers an opening formed in the compartment and the incentive object having a progress tracking region with one or more achievement marks;
for each of the incentive objects,
providing a progress token to a child as a reward for an action by the child;
affixing the progress token to an achievement mark in the progress tracking region of the incentive object;
when each of the one or more achievement marks for the incentive object has the progress token affixed thereto, removing the removable cover from the incentive object to open the compartment and reveal the reward object.

11. The method of claim 10, wherein a shape of the progress tracking region and a shape of the removable cover for each incentive object are selected to produce a shape of the incentive object that is relevant to an intent of the game.

12. The method of claim 11, wherein the shape of the progress tracking region and the shape of the removable cover incentive object form an image of a toilet.

13. The method of claim 10, wherein an image is formed or provided on the removable cover for each incentive object.

14. The method of claim 13, wherein the image formed or provided on the removable cover for each incentive object comprises a cartoon image.

15. An apparatus for early childhood training and development, the apparatus comprising:
a plurality of compartments, each compartment having a reward object disposed therein; and
a plurality of incentive objects, each incentive object having a removable cover that covers an opening formed in a corresponding one of the compartments and the incentive object having a progress tracking region with one or more achievement marks.

16. The apparatus of claim 15, wherein a shape of the progress tracking region and a shape of the removable cover for each incentive object are selected to produce a shape of the incentive object that is relevant to an intent of the game.

17. The apparatus of claim 16, wherein the shape of the progress tracking region and the shape of the removable cover incentive object form an image of a toilet.

18. The apparatus of claim 15, wherein an image is formed or provided on the removable cover for each incentive object.

19. The apparatus of claim 18, wherein the image formed or provided on the removable cover for each incentive object comprises a cartoon image.

20. The apparatus of claim 19, wherein the cartoon image comprises one of a plurality of farm animal cartoon images, a plurality of vehicle cartoon images and a plurality of dinosaur cartoon images.
